(19) United States
(12) Patent Application Publication
(10) Pub. No.: US 2026/0070362 A1
(43) Pub. Date: Mar. 12, 2026

(54) DEVICE AND METHOD FOR PRINTING A SUBSTRATE WITH A SEALANT AND/OR ADHESIVE

(71) Applicant: Robert Bosch GmbH, Stuttgart (DE)

(72) Inventors: Fabiano Icisaca Indicatti, Sao Paulo (BR); Michael Raedler, Hamburg (DE)

(21) Appl. No.: 19/108,907

(22) PCT Filed: Sep. 5, 2023
(86) PCT No.: PCT/EP2023/074246

§ 371 Date: Mar. 5, 2025

(30) Foreign Application Priority Data
Sep. 5, 2022 (DE) 10 2022 209 195.7

(51) Int. Cl. B41M 1/12; B41F 15/36; B41F 15/44

(52) U.S. Cl. CPC B41M 1/12; B41F 15/36; B41F 15/44

(57) ABSTRACT

The invention relates to a device for printing a substrate (1) with a sealant and/or adhesive (2), comprising a stencil (3) with an upper side (3.1) and a lower side (3.2) and at least one recess (4) extending from the upper side (3.1) to the lower side (3.2) for receiving the sealant and/or adhesive (2), wherein at least one channel (5) connected to the recess (4) is integrated into the stencil (3).

The invention also relates to a method for printing a substrate (1) with a sealant and/or adhesive (2) using a device according to the invention.

### BACKGROUND

The invention relates to a device and method for printing a substrate with a sealant and/or adhesive. The substrate may in particular be a layer or coating of an electrochemical cell, for example a monopolar or bipolar plate, a separator plate, and/or a membrane electrode assembly. The printing of the substrate with the sealant and/or adhesive serves in particular to form at least one seal of the electrochemical cell.

Electrochemical cells, such as fuel cells, electrolysis cells, or battery cells, have a multilayer or multi-coating design. This design requires intermediate seals to separate the media supplied to one another during operation of a cell. To form the seals, a sealant and/or adhesive is applied to a layer or coating of the cell. Dispensing or printing methods are used in particular.

Mass production of electrochemical cells requires a high processing speed, i.e. short cycle times, as well as high process stability. Template printing in particular meets these requirements. In principle, the printing process for template printing is divided into the following three sub-processes:
1. applying the sealant and/or adhesive on the template previously placed on the substrate to be printed,
2. filling the template recess(es) with the sealant and/or adhesive in a doctor blade process,
3. triggering the sealant and/or adhesive from the template recess(es) by separating the template from the substrate.

The template thickness determines the layer height of the applied structure, wherein usual layer heights are in the range of 300 μm to 500 μm. However, for seals of electrochemical cells, layer heights of up to 1500 μm are required in order to achieve tolerance compensation and to be as free as possible in the design of the structures to be applied. This is because-depending on the respective sealing concept-the structures to be applied can be large and/or complex.

Accordingly, thicker templates must be used to achieve the layer heights required for seals of electrochemical cells in template printing. However, this increases the risk of air bubbles being incorporated during the doctor blade process for filling the template recess(es) with the applied sealant and/or adhesive, which subsequently lead to defects. This is because the volume of the template recess(es) to be filled with the sealant and/or adhesive also increases with the template thickness.

This problem is explained below with reference to FIGS. 1a) and 1b), which show a template 3 placed on a substrate 1 with a recess 4, which must be filled with a sealant and/or adhesive 2. To this end, a doctor blade 12 is drawn over the upper side 3.1 of the template 3. Towards the end of the recess 4, not all the air can be forced out of the recess 4, so that an air bubble 13 forms in the recess 4, which prevents the recess 4 from being completely filled. In this case, the printed image is incomplete or has defects. The risk of an enclosed air bubble 13 increases with the thickness d of the template 3.

The present invention is concerned with the task of reducing the risk of air bubbles and thus defects when printing a substrate with a sealant and/or adhesive.

To solve the problem, the device according to the disclosure and the method according to the disclosure are proposed.

### SUMMARY

The proposed device for printing a substrate with a sealant and/or adhesive comprises a stencil having an upper side and a lower side, and at least one recess extending from the upper side to the lower side for receiving the sealant and/or adhesive. At least one channel connected to the recess is integrated into the stencil.

The at least one channel integrated into the stencil allows venting of the recess when filling with the sealant and/or adhesive so that the risk of an air bubble remaining in the recess decreases. The venting via the channel thus helps to avoid defects in the print image, which is particularly important when the printing process is used to form a seal.

As the risk of air bubbles forming is minimized, the stencil thickness can be increased so that layer thicknesses significantly higher than 300 μm, for example 1500 μm, can be realized, as required for seals in electrochemical cells.

The location, shape and/or size of the at least one channel depends on various factors.

The layer is predominantly provided by the doctor blade direction, i.e. the stripping direction of the doctor blade, and by the shape of the structure, in particular the sealing structure, to be applied. For example, the structure may be a self-contained shape with end and/or corner regions that are hard to fill. The at least one channel is then preferably arranged in such an end and/or corner region, namely in such a manner that it lies adjacent to and/or behind the recess in the doctor blade direction. Ideally, the channel is adjacent to a region of the recess that is the last to be filled with the sealant and/or adhesive. If the channel is sufficiently large so that it can be filled with sealant and/or adhesive itself, it is preferably arranged such that it is the last to be filled with the sealant and/or adhesive. In this case, the channel serves as a type of overflow that first receives the air forced out of the recess and thereafter excess sealant and/or adhesive.

The shape and/or size of the channel is ideally adapted to the rheological properties, in particular to the viscosity, sealant and/or adhesive. Moreover, it is decisive for the shape and/or size of the channel whether it is for venting only or also to have an overflow function.

The number of channels may also vary and depends in particular on the complexity of the structure being printed. Because the more complex the structure, the more complex the shape of the at least one recess in the stencil is, and so it may be difficult to vent in many regions. A channel can then be arranged in these areas. When arranging the channels, the doctor blade direction must again be observed.

The doctor blade direction need not be predetermined from the outset; it can also only result from the position of at least one channel. This results in greater freedom in the arrangement of the at least one channel. When printing on the substrate, the doctor blade direction must then be selected such that the recess in the region of the channel is filled with the sealant and/or adhesive last during stripping by the doctor blade.

According to a preferred embodiment of the invention, the at least one channel extends from the upper side to the lower side of the stencil and extends the recess in regions, preferably in an end and/or corner region of the recess. As the channel is guided from the upper side to the lower side—analogous to the recess—it can be formed in one work step together with the recess in the stencil, for example by cutting out or punching out. In this case, the stencil is easy and inexpensive to manufacture. The extension of the recess created by the channel can serve not only to vent but, if necessary, also to receive excess sealant and/or adhesive, so that the channel forms a type of overflow.

To extend the recess of the stencil, the channel may be configured as a protrusion of the recess. In an arrangement of the channel in an end and/or corner region of the recess, the protrusion may extend the recess beyond the end and/or corner region. In this case, the extension is preferably in the doctor blade direction.

According to a preferred embodiment of the invention, the at least one channel extends from the upper side of the stencil to a limiting wall of the recess. That is to say, the channel opens in the recess or runs from the recess to the upper side of the stencil. For this purpose, the channel has an oblique or angular profile at least in sections. An oblique profile can be realized comparatively simply, for example by a simple inclined bore. For an angled profile, the channel is preferably composed of a plurality of sections, wherein at least one section can also be designed as a bore. This can then be guided perpendicularly through the stencil.

Furthermore, as a bore is comparatively simple and inexpensive to realize, it is further proposed that the at least one channel is embodied at least in sections as a bore formed in the stencil.

If the at least one channel is composed of a plurality of sections, the sections may have different cross-sections. That is to say, the cross-section of the at least one channel may vary over its entire length. This is particularly advantageous if the channel has an angled profile or is composed of at least two sections that are angularly aligned with each other.

According to a preferred embodiment of the invention, at least one shoulder reaching up to the recess is introduced, in particular milled, at the lower side of the stencil, from which the at least one channel, preferably as a bore, is guided to the upper side of the stencil. Thanks to the at least one shoulder, the channel or the bore can be guided perpendicularly through the stencil, as the necessary connection of the channel to the recess to be vented can be produced via a further channel section that extends transversely to the channel or the bore and is limited by the shoulder of the stencil reaching up to the recess.

As a further measure, it is proposed that the at least one further shoulder reaching up to the recess is introduced, in particular milled, at the lower side of the stencil, wherein in the region of the further shoulder a plate is inserted, preferably sealed or glued, into the stencil which together with the first shoulder limits the channel at least in sections. As the platelet is only inserted in the region of the further shoulder, a cavity remains between the platelet and the first shoulder, which is open towards the recess but closed towards the lower side of the stencil by the platelet. A connection of the channel for the recess is then made via this cavity or the cavity itself forms a portion of the channel.

The platelet inserted into the stencil can be made of, for example, metal or plastic. By welding or gluing the platelet, it is also securely retained in the stencil after a variety of printing and cleaning cycles.

Advantageously, the platelet is flush with the lower side of the stencil. This further ensures a surface contact of the stencil with the substrate during printing. Furthermore, it also prevents the sealant and/or adhesive from entering under the stencil during printing and giving the printed structure an unclean contour.

The stencil of a device according to the invention may comprise a channel or multiple channels for venting the at least one recess. If the stencil comprises more than one channel, the plurality of channels can be the same or configured differently. That is to say, the various embodiments of a channel described above may be realized in different combinations in a stencil. For example, the stencil may comprise at least one channel guided from the upper side to the lower side of the stencil and at least one further channel guided from a limiting wall of the recess to the upper side of the stencil.

In a further development of the invention, it is proposed that the device comprises a doctor blade for stripping the sealant and/or adhesive on the upper side of the stencil. With the aid of the doctor blades, the at least one recess of the stencil is filled with the sealant and/or adhesive during stripping. The doctor blade is preferably wider than the at least one recess so that it can be filled with the sealant and/or adhesive in only one stripping process.

Furthermore, a method for printing a substrate with a sealant and/or adhesive using a device according to the invention is proposed. The method comprises the steps of:
placing the stencil on the substrate so that the lower side of the stencil is in surface contact with the substrate,
applying the sealant and/or adhesive onto the upper side of the template,
filling the at least one recess of the stencil with the sealant and/or adhesive with the aid of a doctor blade which is drawn towards the at least one channel above the upper side of the stencil, wherein air present in the recess is forced out of the recess via the at least one channel.

The location of the at least one channel determines the doctor blade direction, that is to say the direction of movement of the doctor blade. This is selected so that the air present in the recess is forced towards the at least one channel by the sealant and/or adhesive that is pushed into the recess during stripping by the doctor blade. The remaining air can thus escape via the at least one channel so that the recess fills completely with sealant and/or adhesive. In this way, air bubbles and thus defects of the printed structure are avoided.

Preferably, when filling the at least one recess of the stencil with the sealant and/or adhesive, an area of the recess or the channel directly adjacent to the channel itself is the last to be filled. The channel thus remains open until the end to ensure the necessary venting of the recess. If the channel can also receive sealant and/or adhesive due to its shape and/or dimensions, it also forms a type of overflow for excess sealant and/or adhesive. However, unlike the recess, the channel does not need to be completely filled with sealant and/or adhesive, as it is not part of the structure to be applied.

The doctor blade is preferably attached to an end of the stencil that is furthest from the at least one channel for venting the recess. The doctor blade is then first drawn over the recess and lastly over the channel during stripping. This does not exclude that there are further channels for venting the recess that are not behind the recess in the doctor blade direction.

### BRIEF DESCRIPTION OF THE DRAWINGS

Preferred embodiments of the invention are described in greater detail hereinafter with reference to the accompanying drawings. Shown are:

FIG. 1 a) and b) a longitudinal section through a conventional device for printing a substrate during stripping using a doctor blade,

FIG. 2 a) a lower side view of, b) a longitudinal section through a first device according to the invention for printing a substrate with a sealant and/or adhesive,

FIG. 3 a) a lower side view of, b) a longitudinal section through a second device according to the invention for printing a substrate with a sealant and/or adhesive,

FIG. 4 a) to h) a perspective representation of a stencil of a third device according to the invention when gradually introducing a channel,

FIG. 5 a plan view of a stencil of a fourth device according to the invention,

FIG. 6 a plan view of a substrate having a printed structure produced using the stencil of FIG. 5,

FIG. 7 a plan view of a substrate having a printed structure made using a modified stencil, and

FIG. 8 an enlarged section of FIG. 7 and FIG. 8, respectively, in a corner region of the seal.

### DETAILED DESCRIPTION

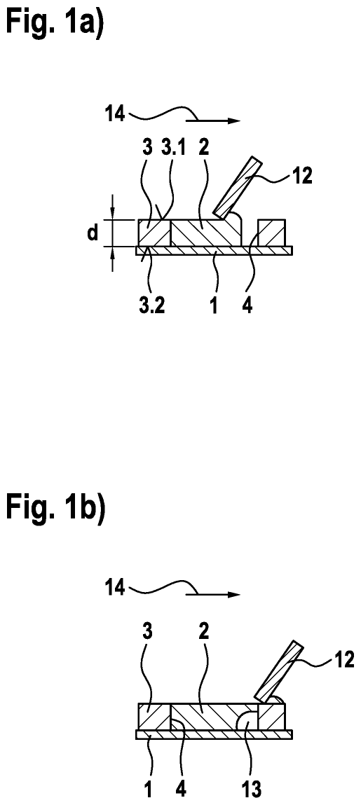

FIGS. 1a) and 1b) have already been used to describe the problem of air bubble formation during template printing in the description introduction, so that reference is made to the description in relation to FIGS. 1a) and 1b).

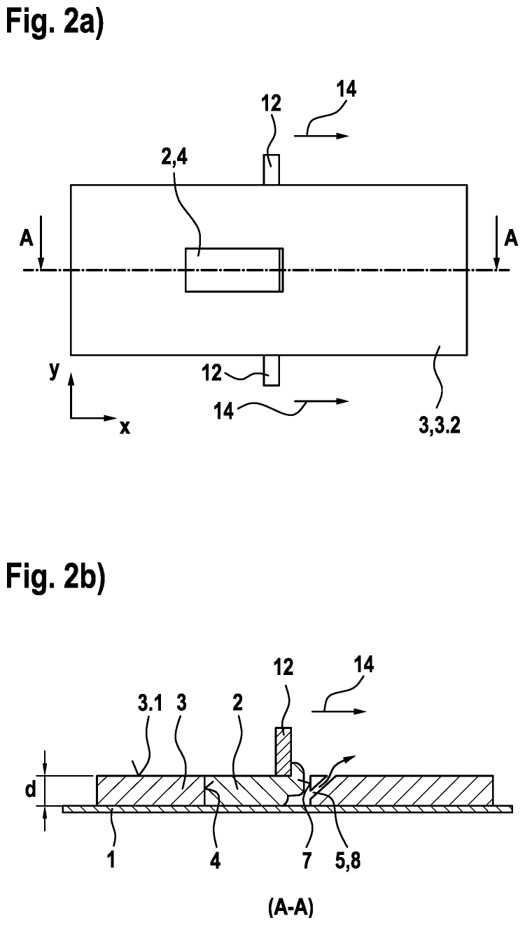

Preferred embodiments of a device according to the invention for printing a substrate with a sealant and/or adhesive are described in more detail below with reference to FIGS. 2 to 8.

The substrate 1 may in particular be a layer or coating of an electrochemical cell, for example a bipolar plate or a membrane-electrode assembly. By printing the substrate 1 with a sealant and/or adhesive 2, a seal 17 of the electrochemical cell in particular can be formed.

FIGS. 2a) and 2b) show a first preferred embodiment of a device for printing a substrate 1 with a sealant and/or adhesive 2. The device comprises a stencil 3 and a doctor blade 12. In order to print on the substrate 1, the stencil 3 is first placed so that a lower side 3.2 of the stencil 3 is in surface contact with the substrate 1. The sealant and/or adhesive 2 is then applied to an upper side 3.1 of the stencil 3 and stripped with the aid of the doctor blade 12. The doctor blade 12 thereby pushes the sealant and/or adhesive 2 into at least one recess 4 formed in the stencil 3. As the recess 4 extends from the upper side 3.1 to the lower side 3.2 of the stencil 3, the thickness d of the stencil 3 determines the layer height of the applied sealant and/or adhesive 2 and thus the height of the later structure and/or seal 17.

The greater the thickness d of the stencil 3, the greater the risk of air bubble formation when stripping (see FIG. 1b)). To avoid air bubbles 13, the stencil 3 shown in FIGS. 2a) and 2b) comprises a channel 5 connected to the recess 4, which serves to vent the recess 4 when stripping with the aid of the doctor blade 12. The channel 5 is arranged behind the recess 4 in the doctor blade direction 14 (see arrow). In the present case, the channel 5 is embodied as an oblique bore 8, which extends from a limiting wall 7 of the recess 4 to the upper side 3.1 of the stencil 3. The diameter of the channel 5 is sized sufficiently large so that air can flow through it unhindered.

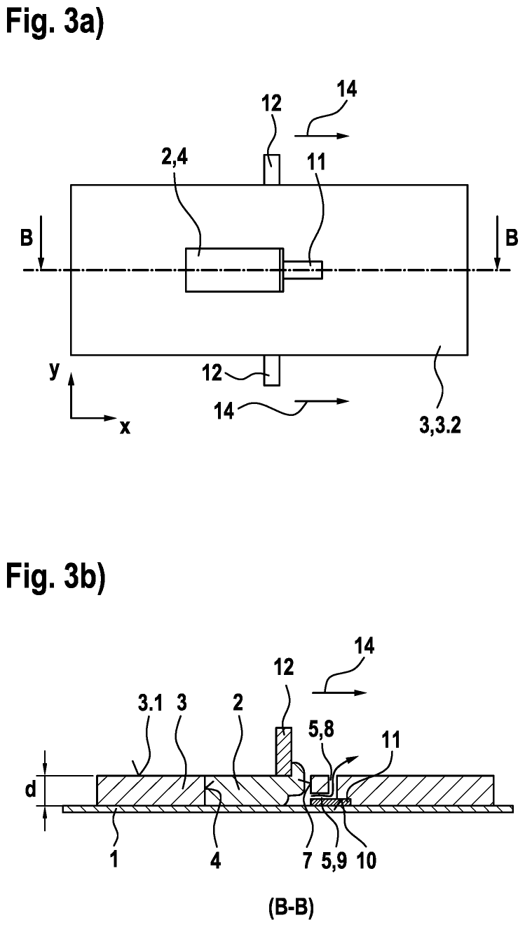

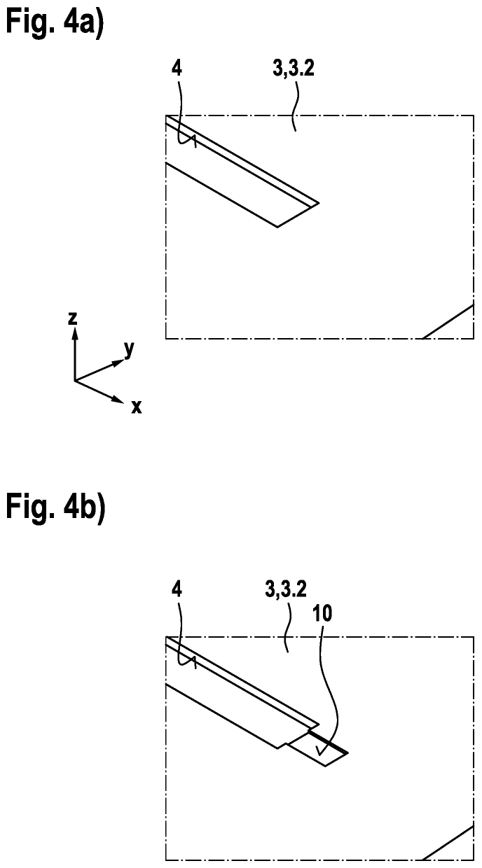

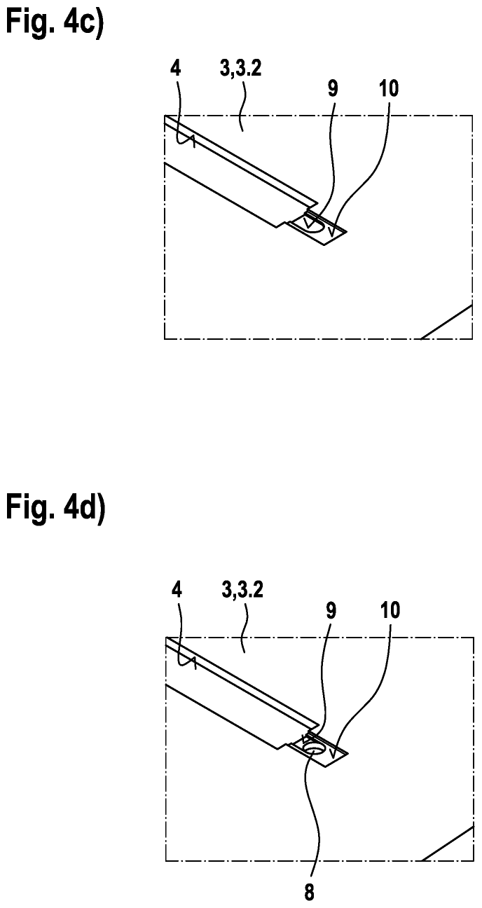

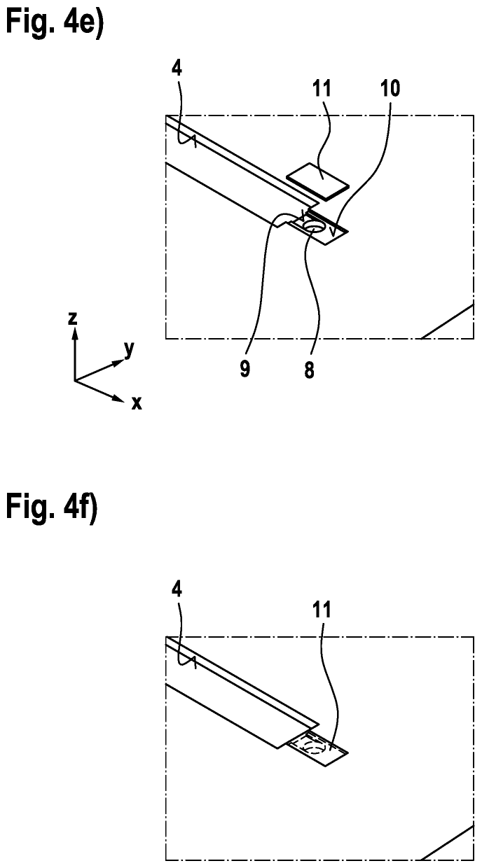

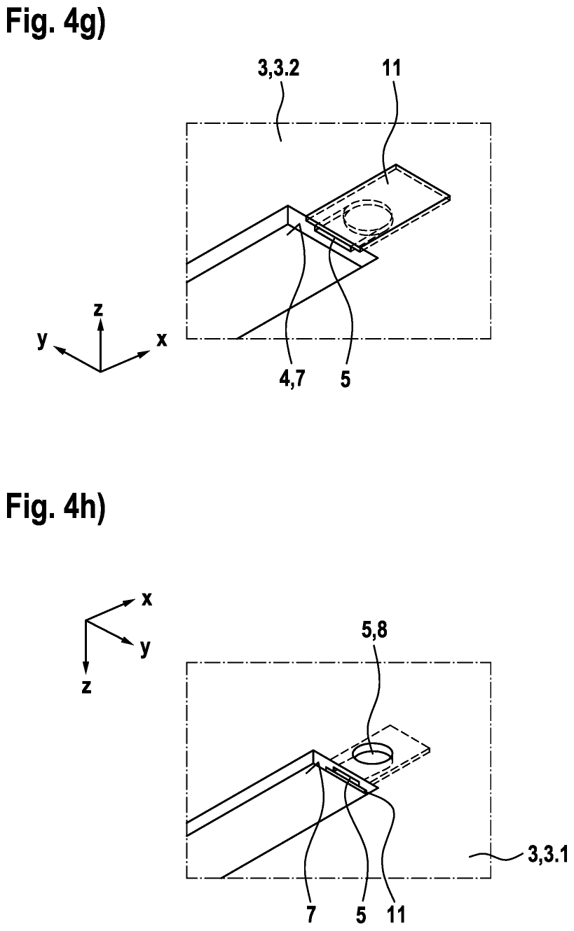

Another preferred embodiment of the device according to the invention is shown in FIG. 3a) to 3b). This also comprises a stencil 3 with an upper side 3.1 and a lower side 3.2, as well as a recess 4, which is formed in the stencil 3 and extends from the upper side 3.1 to the lower side 3.2. To vent the recess 4, a channel 5 is formed in the stencil 3, which is not oblique but angular, in the doctor blade direction 14 behind the recess 4. The channel 5 thus comprises a plurality of sections that are introduced in the production of the stencil 3 in a plurality of work steps. These work steps are shown by way of example in FIG. 4a) to 4h).

FIG. 4a) shows the stencil 3 with the recess 4 in a lower side view, still without channel 5. To form the channel 5, a shoulder 10 is first introduced on the lower side 3.2 of the stencil 3, which reaches up to the recess 4 (see FIG. 4b)). Within this shoulder 10, a further shoulder 9 is formed (see FIG. 4c), which also reaches up to the recess 4, so that it is bordered on three sides by the shoulder 10. The shoulder 9 is rounded at its end facing away from recess 4. In the region of the rounded end, a bore 8 is subsequently introduced (see FIG. 4d) that extends from the shoulder 9 to the upper side 3.1 of the stencil 3. In order to close the channel 5 on the substrate side, a platelet 11 is inserted, preferably sealed or glued, into the stencil 3 (see FIG. 4e)) in such a way that the platelet 11 is flush with the lower side 3.2 of the stencil 3 (see FIG. 4f)). As both shoulders 9, 10 reach up to the recess 4, the channel 5 emerges at one end in the limiting wall 7 (see FIG. 4g)) and at the other end on the upper side 3.1 of the stencil 3 (see FIG. 4h)).

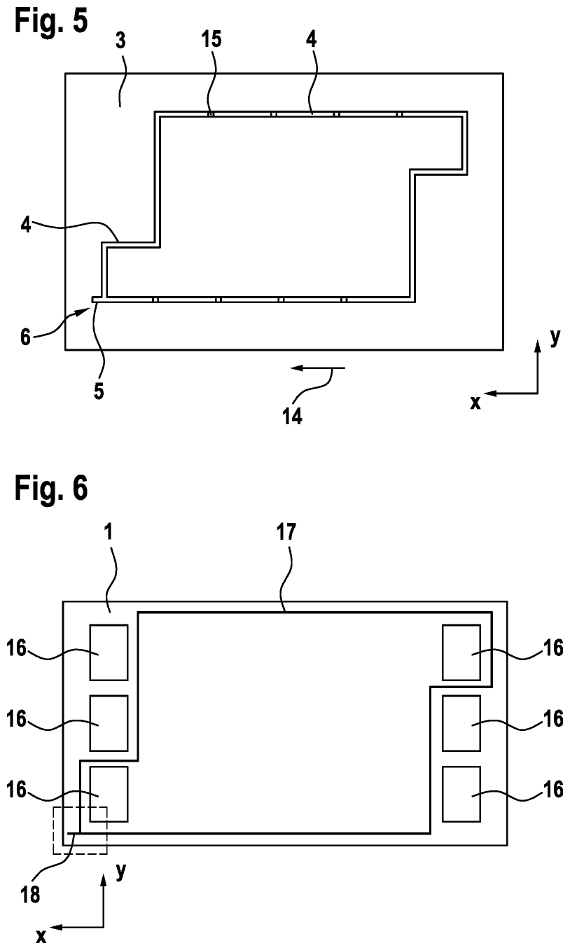

FIG. 5 shows a further preferred embodiment of a device according to the invention. Only the stencil 3 of the device is shown, namely in an upper side view. The stencil 3 comprises a recess 4 for forming a circumferential seal 17 on a bipolar plate (see FIG. 6), so that the bipolar plate forms the substrate 1 to be printed. The bipolar plate shown in FIG. 6 comprises a plurality of ports 16 for the passage of different media. The seal 17 is for media separation.

As the seal 17 is circumferential, the recess 4 divides the stencil 3 into an inner and an outer portion. These are connected via bars 15 (see FIG. 5). The bars 15 have a thickness that is less than the thickness d of the stencil 3, so that the substrate 1 can also be printed with the sealant and/or adhesive 2 in the region of the bars 15.

The stencil 3 shown in FIG. 5 comprises a channel 5 in an end and/or corner region 6 of the recess 4, which extends or lengthens the recess 4 in the doctor blade direction 14. The channel 5 extends—like the recess 4—from the upper side 3.1 to the lower side 3.2 of the stencil 3. When stripping the sealant and/or adhesive 2 with a doctor blade 12, it is drawn over the channel 5 last, so that air present in the recess 4 is completely removed and the recess 4 is completely filled with the sealant and/or adhesive 2. Excess sealant and/or adhesive 2 is drawn into the channel 5, so that the channel 5 may also be filled with sealant and/or adhesive 2—in whole or in part. Accordingly, a seal 17 produced in this way can have a run 18 formed from excess sealant and/or adhesive 2 (see FIG. 6 as well as FIG. 8). The run 18 has no sealing function. Furthermore, the sealing function of the seal 17 is not affected by the run 18.

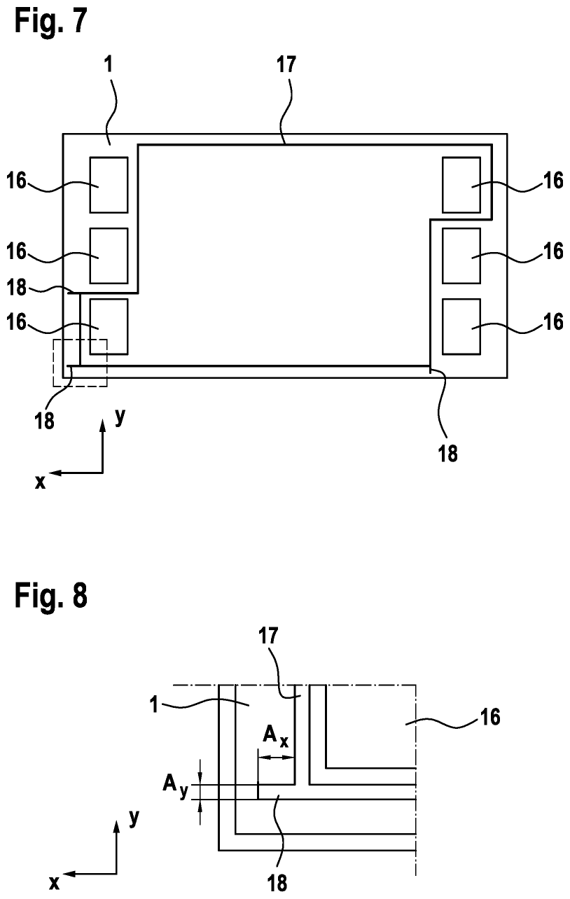

A modified seal 17 is shown in FIG. 7. Here, the seal comprises a total of three runs 18 because a stencil 3 with a plurality of channels 5 was used to manufacture the seal 17 (not shown). The position of the run 18 corresponds to the position of the channels 5 for ventilation. Accordingly, a second channel 5 is provided in a further corner and/or end region 6 of the recess 4. A third channel 5 is arranged laterally on the recess 4, so that the third run 18 comes laterally to the side. If the doctor blade 12 is pulled from right to left over the stencil 3 during stripping, air can also escape from the recess 4 via the laterally arranged channel 5.

1. A device for printing a substrate (1) with a sealant and/or adhesive (2), the device comprising: a stencil (3) with an upper side (3.1) and a lower side (3.2) and at least one recess (4) extending from the upper side (3.1) to the lower side (3.2) for receiving the sealant and/or adhesive (2), wherein at least one channel (5) connected to the recess (4) is integrated into the stencil (3).

2. The device according to claim 1,
wherein the at least one channel (5) extends from the upper side (3.1) to the lower side (3.2) of the stencil (3) and the channel (5) extends in regions of the at least one recess (4).

3. The device according to claim 1,
wherein the at least one channel (5) extends from the upper side (3.1) of the stencil (3) to a limiting wall (7) of the at least one recess (4) and at least partially has an oblique or angular profile.

4. The device according to claim 1,
wherein the at least one channel (5) is embodied at least in sections as a bore (8) formed in the stencil (3).

5. The device according to claim 1,
wherein at least one shoulder (9) reaching up to the at least one recess (4) is introduced at the lower side (3.2) of the stencil (3), from which the at least one channel (5) is guided up to the upper side (3.1) of the stencil (3).

6. The device according to claim 5,
wherein at least one further shoulder (10) reaching up to the at least one recess (4), is introduced at the lower side (3.2) of the stencil (3), wherein in a region of the further shoulder (10) a platelet (11) is inserted into the stencil (3) which together with the at least one first shoulder (9) limits the at least one channel (5) at least in sections.

7. The device according to claim 6,
wherein the platelet (11) is flush with the lower side (3.2) of the stencil (3).

8. The device according to claim 1,
wherein the device comprises a doctor blade (12) for removing the sealant and/or adhesive (2) on the upper side (3.1) of the stencil (3).

9. A method for printing a substrate (1) with a sealant and/or adhesive (2) using a device according to claim 1, the method comprising:
placing the stencil (3) on the substrate (1) so that the lower side (3.2) of the stencil (3) is in surface contact with the substrate (1),
applying the sealant and/or adhesive (2) on the upper side (3.1) of the stencil (3),
filling the at least one recess (4) of the stencil (3) with the sealant and/or adhesive (2) with a doctor blade (12) which is drawn towards the at least one channel (5) above the upper side (3.1) of the stencil (3), wherein air present in the at least one recess (4) is forced out of the at least one recess (4) via the at least one channel (5).

10. The method according to claim 9,
wherein when filling the at least one recess (4) of the stencil (3) with the sealant and/or adhesive (2), a region (13) of the at least one recess (4) or the at least one channel (5) directly adjacent to the at least one channel (5) itself is the last to be filled.

11. The device according to claim 2, wherein the at least one channel (5) extends in and end and/or corner region (6) of the recess (4).

12. The device according to claim 5, wherein the at least one shoulder (9) reaching up to the at least one recess (4) is milled in the lower side (3.2) of the stencil (3).

13. The device according to claim 6, wherein the at least one further shoulder (10) reaching up to the at least one recess (4) is milled in the lower side (3.2) of the stencil (3).

14. The device according to claim 6, wherein the platelet (11) is sealed or glued into the stencil (3).
